(19) United States
(12) Patent Application Publication
(10) Pub. No.: US 2003/0140768 A1
(43) Pub. Date: Jul. 31, 2003

(54) Visual display

(76) Inventor: Christopher J A Barnardo, Stortford (GB)

Correspondence Address: Daniel J Warren, Sutherland Asbill & Brennan, 999 Peachtree Street NE, Atlanta, GA, 30309-3996, US

(21) Appl. No.: 10/204,253

(22) PCT Filed: Feb. 19, 2001
(86) PCT No.: PCT/EP01/01851

(30) Foreign Application Priority Data
Feb. 17, 2000 (GB) 0003642.6

(51) Int. Cl. G09B 15/02

(52) U.S. Cl. 84/477 R

(57) ABSTRACT

A device for visually displaying varying two-dimensional vector-type information, such as the frequency and amplitude of an audio signal. The device has an electroluminescent lamp and a supply voltage generator. The supply voltage generator receives an input signal including the vector-type information and provides an alternating supply voltage to the electroluminescent lamp. The amplitude of the supply voltage is representative of one dimension of the information and the frequency of the supply voltage is representative of the other dimension of the information. The first dimension, e.g. the audio signal amplitude, is displayed as a varying brightness of the electroluminescent lamp and the second dimension, e.g. the audio signal frequency, is displayed as a varying colour of the electroluminescent lamp. The device provides a simple, analogue visual display of the information.

The present invention relates to visual displays, specifically to a visual display which is capable of displaying varying two-dimensional vector-type information. Varying two-dimensional vector-type information may be in the form of a representation of at least two related variables or quantities, i.e. the dimensions or components of the vector. For example, in an audio hi-fi environment, vector-type information could include the amplitude and frequency of the audio signal.

Visual display means for displaying varying two-dimensional vector-type information are needed in many different situations for displaying various types of information such as:

display of volume and tone on audio systems;

display of heat and stress over an area;

display of heat and pressure over an area;

display of noise and vibration in a component.

Each displayed component may be independent of or dependent on the other display component. It is not necessary that both dimensions of the vector always vary.

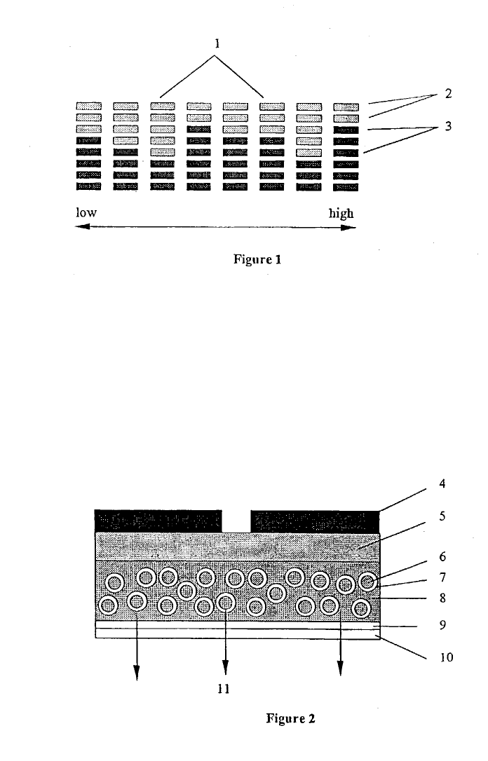

Typically, two-dimensional vector-type information such as frequency and amplitude (tone and volume) of an audio signal (typically music) is displayed as in FIG. 1 using a number of bar (stack or column) type displays (1) that individually show the amplitude of discrete frequency ranges, for instance by lighting up (3) or remaining unlit (2). In this example of a prior art display, the tonal structure of the whole signal is represented by an array of juxtapositioned bar displays. Thus the tonal balance of the music may be deduced by watching the shape of the array. Each bar and thus the whole display may, for instance, be made up of arrays of individual light emitting diodes (LEDs).

Some prior art displays also incorporate some form of memory so that the peak height of each bar (1) remains illuminated for a certain period after the amplitude has reduced for that particular frequency range thus adding a historical element to such a display.

These prior art methods of displaying two-dimensional vector-type information have many drawbacks:

they require some form of logic control circuit in order to operate;

resolution in one of the dimensions to be displayed is limited by the number of LEDs in each bar, stack or column;

resolution in the other dimension is limited by the number of bars, stacks or columns in the array; and

they are relatively expensive to produce.

Thus the representation afforded by these prior art displays is always limited by the need to restrict such representation to a limited number of discrete ranges.

Graphical representation of tone and volume using the method described above has been widely used, and although well understood by the consumer, does not offer anything new in the hi-fi market, a market dominated by innovation.

Electroluminescence (EL) which is the emission of light under electric-field excitation is also known in the art. A typical known thick-film (or powder) phosphor EL device as shown in FIG. 2 comprises a light emitting material (6) in a dielectric matrix (8), sandwiched between two conducting electrodes (4, 9).

It is known in the art to construct, for instance, lamps from EL material. The benefits of phosphor EL lamps are that they can be made very thin (<0.3 mm), they are flat and fully flexible (when applied to a flexible plastic substrate (10), are rugged, have a wide viewing angle, can be made quite cheaply, can be made in low volumes using simple techniques, and give off very little heat when emitting light. Typically they are used for backlighting LCD displays (e.g. watches, mobile phones, etc.) and instrument panels.

Phosphor EL lamps can be dc-driven by low voltage circuits (1.5-5V) by using inverters and inductors generating AC voltages of, for example, 100 to 300V (peak to peak) at frequencies of 50 to 1,000 Hz. These EL devices can generate luminances of 10-100 cd/m². Specific lamp/driver arrangements will deliver a lamp half-life of between 3,500 and 10,000 hrs. EL lamps are used when an application indicates a need for soft, uniform light emission with a wide viewing angle, operating over a wide temperature range (−40° C. to +700° C.), and vibration and shock resistance.

In the recent development and commercialisation of the phosphor EL lamp, much effort has been applied to making brighter phosphors which emit more even light and which have extended usable lifetimes. In many cases this has led to refinement of the drive strategies to find a match of drive frequency with voltage.

The present invention aims to provide, in at least the preferred embodiment, a display for two-dimensional vector-type information which overcomes at least some of the drawbacks of prior art displays.

Viewed from a first aspect, the invention provides a method of visually displaying varying two-dimensional vector-type information comprising the steps of representing one dimension of the information by the amplitude of a representative signal, representing the other dimension of the information by the frequency of the representative signal and using the representative signal to light an electroluminescent lamp.

Viewed from another aspect, the invention provides a visual display means (or device) which displays varying two-dimensional vector-type information represented by the amplitude and frequency components of a representative signal and which comprises an electroluminescent lamp driven by said representative signal.

Viewed from a yet further aspect, the invention provides apparatus for visually displaying varying two-dimensional vector-type information,

the apparatus comprising an electroluminescent lamp and a supply voltage generator arranged to receive at least one input signal including the vector-type information and to provide an alternating supply voltage to the electroluminescent lamp, such that the amplitude of the supply voltage is representative of a first dimension of the information and the frequency of the supply voltage is representative of a second dimension of the information,

whereby the first dimension is displayed as a varying brightness of the electroluminescent lamp and the second dimension is displayed as a varying colour of the electroluminescent lamp.

At least in its preferred embodiment, the invention eliminates the need for any complex logic control needed for the active prior art displays, to visually represent varying two-dimensional vector-type information.

Thus, the present invention allows the provision of a display for two-dimensional vector-type information which does not require a complex logic control, which does not have imposed limits of resolution due to its configuration and which is cheap and easy to produce.

An EL display is generally much simpler to mount in any piece of equipment than a prior art display.

The invention gives an analogue representation of the applied information signal, for example audio signal, that does not suffer the limitations of the bar, column or stack arrays, with respect to limitations of resolution. Such an analogue display gives far more qualitative data.

The invention elegantly solves the problem of creating a simple and cheap display for varying two-dimensional vector-type information.

Further features and advantages of the invention will become apparent from a consideration of the ensuing description and with reference to the figures.

Some embodiments of the invention will now be described, by way of example only, and with reference to the accompanying drawings, in which:

FIG. 1 is a schematic representation of a prior art display; and

FIG. 2 is a schematic representation of an electroluminescent lamp.

FIG. 2 shows a typical EL lamp. The main features of the lamp are electroluminescent particles (6), such as phosphor, which are held between two electrodes (4, 9), one of which is a transparent electrode (9)—often referred to as ITO (indium tin oxide). The particles may be encapsulated in glass or ITO beads (7) and held in a dielectric matrix (9). A further layer of dielectric (5) may be provided in order to avoid short circuiting problems and the whole lamp is laid out on a substrate (10) of some sort - typically glass or plastic. When an electric field is present between the two electrodes (4, 9), the EL lamp emits light (11).

In the following, phosphor is used as an example of an electroluminescent material. Other substances may be used for the same purpose without departing from the invention.

Also, in the following the invention is described according to the particular embodiment which displays tone and volume for an audio system. However, it is possible to substitute any varying two-dimensional vector-type information without departing from the invention.

The new and inventive way of representing two dimensional data streams is realised by using the frequency and voltage response of the phosphor material itself. Phosphor EL material exhibits a reproducible change of colour in the emitted light with change in the ac drive frequency. In addition, phosphor EL material exhibits a reproducible change of brightness of the light emitted with change in drive voltage.

In normal operation, when a predetermined voltage is reached (for example, approx. 70 Vac), the emitter component of the phosphor compound breaks down and emits light. Thereafter, as the drive voltage is increased, the light emitted from the lamp increases in brightness (to a certain point). Within a certain range (which differs for each phosphor formulation) the brightness of the device is proportional to the applied drive voltage. In a similar way frequency affects the wavelength (colour) of the light emitted. When a predetermined frequency is reached (for example approx. 400 Hz) the emitter component of the phosphor compound is excited to emit light of a certain wavelength. Thereafter, as the drive frequency is increased (up to say 10 kHz), the wavelength of light emitted by the lamp is reduced, visibly shifting the colour of the display output. Within a certain range (which differs for each phosphor formulation), the wavelength of the light produced is inversely proportional to the applied drive frequency. Thus, for example, in a blue-green display, the colour may be changed from dark green, through cyan to dark blue by varying the drive frequency.

By combining these two solid-state phosphor material characteristics and using an amplified audio speaker output signal as the input to the EL display, a single flat lamp display is created which comprises a simple electrode-phosphor-dielectric-electrode laminate structure that can be used to display frequency and amplitude simultaneously.

In such a display a shift in colour represents changes in tone and the variation in the brightness of the lamp represents changes in amplitude (in the case of amplified music, this represents volume).

Such a display can be used to represent any rapidly changing two dimensional vector-type information e.g. heat and pressure in a turbine blade, or stress loading and vibration in a machine component, etc.

In an audio or hi-fi application, the invention provides a novel way of displaying the audio signal and will provide a new type of display for the hi-fi market.

The qualitative nature of the display is also useful for the profoundly deaf in helping understand the nature of sound, in particular music and speech.

Using different colour phosphors, a very cheap display can be made that displays a greater range of the visible spectrum.

A thin film display (<0.3 mm thickness) can be adhesively bonded to any flat surface. It is very easy and cheap to construct and to mount within a stereo cabinet or in any other piece of equipment.

In summary, there is described herein a device for visually displaying varying two-dimensional vector-type information, such as the frequency and amplitude of an audio signal. The device has an electroluminescent lamp and a supply voltage generator. The supply voltage generator receives an input signal including the vector-type information and provides an alternating supply voltage to the electroluminescent lamp. The amplitude of the supply voltage is representative of one dimension of the information and the frequency of the supply voltage is representative of the other dimension of the information. The first dimension, e.g. the audio signal amplitude, is displayed as a varying brightness of the electroluminescent lamp and the second dimension, e.g. the audio signal frequency, is displayed as a varying colour of the electroluminescent lamp. The device provides a simple, analogue visual display of the information.

1. An apparatus for
visually displaying varying two-dimensional vector-type information,
the apparatus comprising an electroluminescent lamp and a supply voltage generator arranged to receive at least one input signal including the vector-type information and to provide an alternating supply voltage to the electroluminescent lamp, such that the amplitude of the supply voltage is representative of a first dimension of the information and the frequency of the supply voltage is representative of a second dimension of the information,
whereby the first dimension is displayed as a varying brightness of the electroluminescent lamp and the second dimension is displayed as a varying colour of the electroluminescent lamp.

2. An apparatus as claimed claim 1, wherein the information comprises the amplitude data of an audio signal in the first dimension and the frequency signal of the same audio signal in the second dimension.

3. An apparatus as claimed in claim 1 or 2, wherein the electroluminescent lamp is in the form of a single, flat lamp.

4. An apparatus as claimed in any of claims 1 to 3, wherein the electroluminescent lamp is a thick-film or powder phosphor electroluminescent lamp.

5. An apparatus as claimed in any preceding claim, wherein the input signal is an audio signal and the supply voltage generator is arranged to amplify the input signal to produce the supply voltage.

6. A method of visually displaying varying two-dimensional vector-type information comprising the steps of:
representing one dimension of the information by the amplitude of a representative signal;
representing the other dimension of the information by the frequency of the representative signal; and
using the representative signal to light an electroluminescent lamp
whereby one dimension of the information is thus displayed as a varying brightness of the electroluminescent lamp and the other dimension is thus displayed as a varying colour of the electroluminescent lamp.

7. A method of visually displaying varying two-dimensional vector-type information according to claim 6 wherein said information consists of the amplitude data of an audio signal in one dimension and of the frequency signal of the same audio signal in the second dimension.

8. A method of visually displaying varying two-dimensional vector-type information according to either of claims 6 or 7 wherein the electroluminescent lamp is in the form of a single, flat lamp.

9. A method of visually displaying varying two-dimensional vector-type information according to any of claims 6 to 8 wherein said electroluminescent lamp is a thick-film or powder phosphor electroluminescent lamp.
